(19) United States
(12) Patent Application Publication
(10) Pub. No.: US 2009/0321093 A1
(43) Pub. Date: Dec. 31, 2009

(54) HOME KITCHEN FIRE SUPPRESSION SYSTEM

(76) Inventor: SHLOMO LALOUZ, San Diego, CA (US)

Correspondence Address: INTELLECTUAL PROPERTY BUSINESS CONSULTANTS, PLLC;Attn: Dr. Mario Sergio Golab, 1413 SANTA CRUZ AVE, CORAL GABLES, FL, 33134-2257, US

(21) Appl. No.: 12/164,059

(22) Filed: Jun. 29, 2008

(51) Int. Cl. A62C 37/12; A62C 3/00

(52) U.S. Cl. 169/57; 169/65

(57) ABSTRACT

An automatic fire-suppression system that upon a predetermined fire condition is capable of detecting said fire condition and automatically dispensing and dispersing fire suppressant material over the abnormal fire.

The system is independent of the appliance and does not require any external energy to operate. Furthermore the fire suppression system is capable of disconnecting an external gas or electricity supply line upon a fire condition.

### BACKGROUND OF THE INVENTION

1. Field of the Invention

This invention generally relates to a system to suppress dangerous fires caused by or on cooking appliances. More particularly, this invention relates to a self contained system that can detect a cooking appliance fire condition, such as a prolonged and abnormal kitchen stove top flame or excessive heat emanating from a cooking appliance, and, upon the triggering of a fusible link or other detection means, douse off the abnormal fire with a fire suppressant material while simultaneously disconnecting the cooking appliance supply lines. The fire suppressing system is self contained and powered and requires the same maintenance as a standard fire suppressant canister.

2. Description of Related Prior Art

Since humans started to cook indoors with combustible materials, fuels, or electricity, the risk of fire caused by an accident or failure of the cooking device, became part of daily human life. An uncontrolled and unsuppressed fire, originating on a stove top, could quickly cause serious fire damage, total destruction of the dwelling, and even death of a dwelling's habitants.

Historically cooking fires were regulated and controlled with a mixture of air suffocation and/or water. In modern times, when most kitchens' stove tops are operated with a flammable gas, such as natural gas or liquid propane, or with an electric heating element, the stove top source of cooking heat is controlled through a gas regulator/shut-off valve or an electric rheostat/switch.

When an uncontrolled fire erupts in a modern house's cooking appliance, it frequently goes undetected for some time. The foremost reason for this detection delay is because the independent fire detector is not installed in proximity to the cooking appliance and also because it is designed to detect smoke rather than fire. This detection delay can cause, at a minimum, severe fire destruction to the kitchen furniture and its structure. Today's kitchen fire detection alarms are only geared to alert the house occupants of an occurring smoke, not necessarily the prelude or and indication of an impending fire; but even after sounding an alarm that does not mean that any action will be taking place to suppress a fire. The house's inhabitants will have to recur to some means of fire suppression, such dispensing a fire suppressant from a hand held fire extinguisher canister, suffocating the fire with a thick blanket, or dousing off the flames with water; however, when the cooking appliance is electric of the fire emanates from burning oil, the use of water may have adverse and unforeseen consequences. Obviously, the success from using these fire suppression means depend on a myriad of factors primarily amongst them the reaction time from the time of fire detection to commencing the fire suppression.

Larger homes and commercial establishments may have installed fire extinguishing/suppressing systems that, upon the detection of a fire, could douse-off and possibly extinguish a fire in an entire building, or a substantial portion of it. However, most residential houses are not built with fire extinguishing systems nor such systems are installed after the dwelling is constructed, mainly because the installation of such systems in extremely expensive. At best, most dwellings rely on a replaceable battery-operated smoke alarm as the only means to alert of an impending fire and on a hand held fire extinguisher canister to respond to an already raging kitchen fire.

As of today there are not known fire detection and suppression systems that can detect and suppress a cooking appliance fire effectively and with minimum damage and at a reasonable cost.

### BRIEF SUMMARY OF THE INVENTION

The inventive home kitchen fire suppression system ensures that upon the detection of an abnormal and prolonged fire, a detection means, such as a fusible link or a thermocouple, both well known to a person skilled in the art, activates a fire suppression system that releases a fire dousing quantity of an appropriate fire suppressant material over the source of the fire, extinguishing it before it propagates to other parts of the kitchen or the dwelling. Furthermore, the system immediately disconnects the external source of energy, whether gas or electricity, consumed by the cooking appliance thus depriving the fire of additional combustible material.

### DRAWINGS

FIG. 1a is an embodiment of the invention's preferred deployment.

FIG. 1b is an alternative embodiment of the invention.

FIG. 1c is an alternative embodiment of the invention.

### DETAIL DESCRIPTION OF THE INVENTION

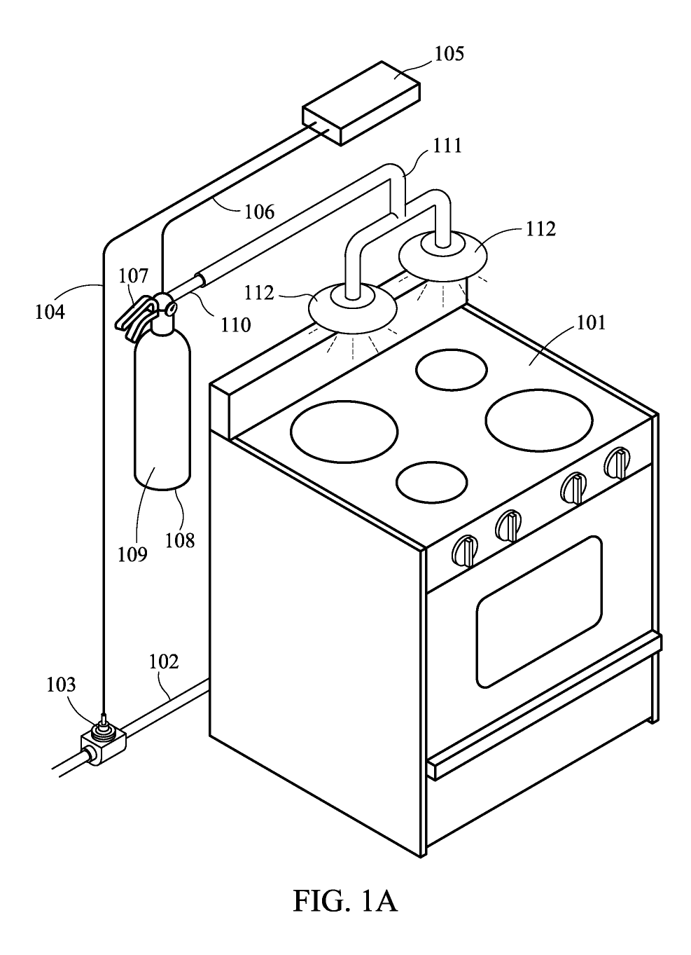

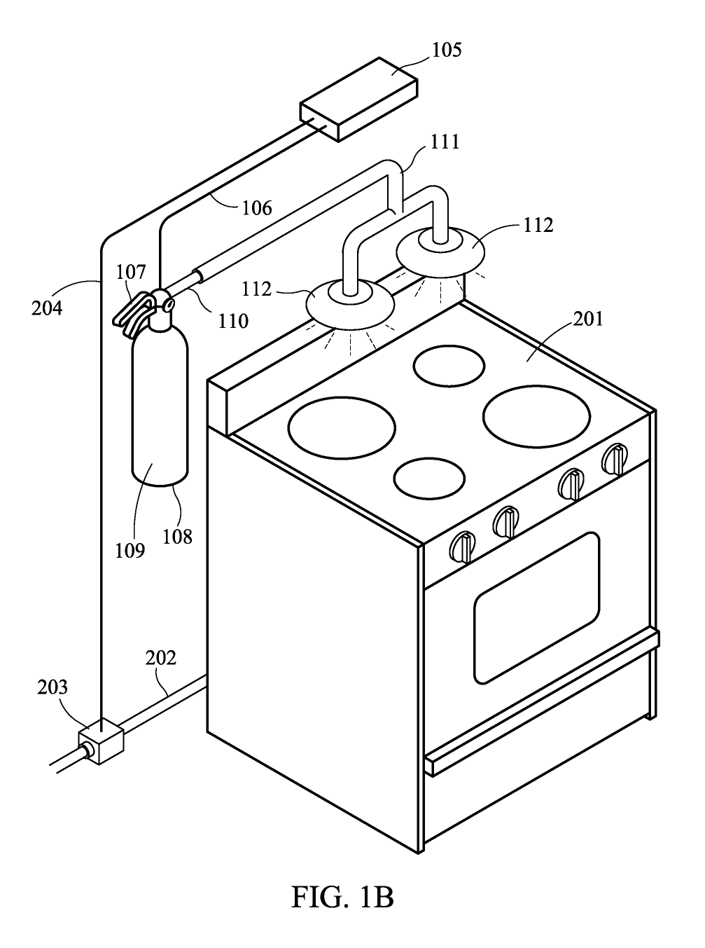

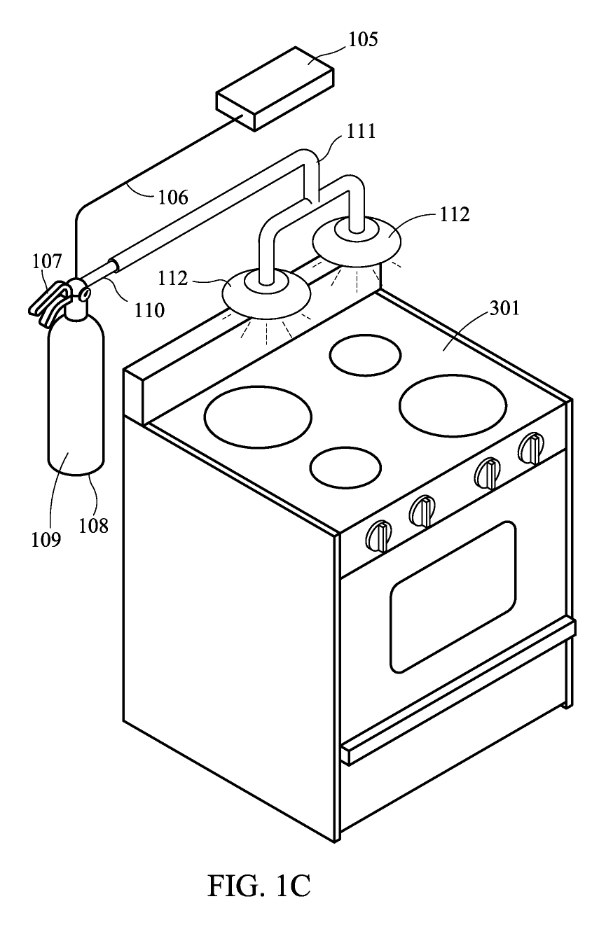

FIG. 1a depicts a preferred embodiment of the invention. A cooking appliance 101 may be operated by gas burner through an externally supplied flammable gas, such as natural gas or liquid propane gas, by an electrically operated heating element through an externally supplied electricity, by an appliance adjacent flammable gas container, such as liquid propane gas or butane gas, or by any flammable material such as coal or wood.

In most modern and urban kitchens the energy consumed by a cooking appliance is supplied through external supply line, such as a gas supply line 102 or and electricity supply line 202 (See FIG. 1b).

In the event the cooking appliance is gas operated, most building codes mandate that an external gas shut-off valve be adjacent to the appliance, however this gas shut-off valve is normally not easily accessible in the event of a fire, lending more consumable energy to an uncontrollable fire.

The inventive home kitchen fire suppression system employs a gas shut-off valve 103 that operates by lifting and releasing an internal spring-activated shut-off mechanism. This spring activated gas shut-off valves are well known to a person skilled in the art. When the spring-activated shut-off mechanism is loaded with a predetermined pulling force, the gas supply line is open and flammable gas flows to the cooking appliance, so long as the pulling force is maintained. When the pulling force is weakened or released, the valve's spring loaded mechanism closes the gas line shutting off the flammable gas supply.

A mechanical link 104 connects the spring loaded gas shut-off valve 103 with a fire condition detector fusible link 105. The mechanical link 104 may be made of any material capable of transmitting with negligible elastic of plastic deformation an axial displacement force of sufficient strength to close the gas shut-off valve upon breaking of the fire condition detector fusible link 105.

The fire condition detector fusible link 105 is a device that, upon being exposed to a continued predetermined temperature that exceeds the fusible element temperature threshold, it ruptures, then releasing any linked element, such as the mechanical link 104 and the canister link 106, attached to it.

The canister link 106 connects the fire condition detector fusible link 105 with a canister access valve 107. The canister access valve 107 has a spring loaded opening mechanism that maintains the valve closed so long as it is under the tension of the canister link 106. When the fire detector fusible link 105 ruptures, the canister link 106 is released, and the canister access valve 107 becomes open by force of its depressed spring.

The canister access valve 107 is mechanically connected to a pressure bearing canister 108 that is capable of containing under pressure a fire extinguishing material 109. Once the canister access valve 107 is opened, the canister's internal pressure forces the fire extinguishing material 109 to flow trough its spout 110. A pressure bearing pipeline 111 connected to the spout 110 channels the fire extinguishing material 109 to one or more dispersing and dispensing nozzles 112. The dispensing and dispersing nozzles 112 may be located preferably close to the cooking appliance 101 burners, either above or adjacent to them.

The home kitchen fire suppression system may be configured to have a plurality of pressure bearing canisters 108 arranged in a multiplicity of locations. Similarly, there may be one or more fire condition detector fusible links 105 deployed at various locations adjacent to the cooking appliance 101 and each one may be calibrated to rupture at a different temperature threshold and time exposure.

While the invention is primarily geared for use in conjunction with cooking appliances, nothing should be interpreted as limiting it use, on the contrary, any device with a source of high heat that may potentially create a fire danger to a dwelling, such as a wood burning stove, a fireplace, a grill, a cooking stove that uses any combustible material, such as coal, wood, charcoal, bottled liquid propane or butane, will add a previously unavailable safety feature by implementing this invention.

FIG. 1b depicts an alternative embodiment of the invention. In the event the cooking appliance is electrically operated, most modern building codes mandate that an external switch control the electricity supply; however under psychological stress of an impending fire, finding the switch/breaker is not always so easy or apparent. Furthermore, because of the electricity, suppressing a raging fire with water is not a practical option and does not eliminate the fire fuel.

In general terms, when the home kitchen fire suppression system is installed in an electrically operated cooking appliance 201, it operates like the previously described gas supplied version 101, with the following differences. The fire detector fusible link 105 is connected to an electrical switch 203, deployed on the cooking appliance electricity supply line 202 and adjacent to the cooking appliance 201, via a mechanical link 204. Alternatively, an electricity generating thermal sensor (not shown), such as a thermocouple, may generate sufficient electricity to operate a solenoid type electrical switch (not shown). The electricity generating thermal sensors and solenoid type valves are well known to a person skilled in the art.

Lastly, FIG. 1c depicts another alternative embodiment of the invention. A cooking/heating appliance 301 may actually be operated with other combustible materials, such as wood, coal, liquid propane containers, etc. The home kitchen fire suppression system will operate in a similar fashion as the previously described gas supplied version, depicted in FIG. 1a with the sole difference that the fire detector fusible link 105 will not be connected to a link to shut-off any external supply line.

The home kitchen fire suppression system may be used as an independent fire suppression system and be placed on an existing cooking or heating appliance set up or may be incorporated as a fire suppression system feature in a new manufactured cooking or heating appliance.

While the home kitchen fire suppression system is designed to be triggered automatically upon a fire condition, the canister access valve 107 can be equipped with a hand operated trigger that can be manually used to override the fire condition detector fusible link 105 and dispense the fire extinguishing material 109 through the system and over the cooking/heating appliance 101, 201, or 301.

1. A fire detection and suppression system, the system comprising:
at least one fire condition detector fusible link capable of being activated upon being exposed to a fire condition for a predetermined amount of time to a predetermined minimum temperature;
a fire extinguisher system disposed in proximity to the at least one fire condition detector fusible link and mechanically connected to it, the fire extinguishing system comprising:
at least one canister, each of the at least one canister comprising:
a fire extinguishing material contained therein;
a spout through which the fire extinguishing material can flow; and
a canister access valve, mechanically coupled to the at least one canister on one end and to the spout on the other end, capable of controlling the flow of fire extinguishing material through it and capable of being mechanically operated;
a mechanical link coupling the at least one fire condition detector fusible link with the canister access valve, the mechanical link capable of transmitting with negligible loss of force an axial displacement force of sufficient strength to open the canister access valve upon rupturing of the at least one fire condition detector fusible link;
a pipeline connected on one end to the spout and;
at least one nozzle capable of dispensing and dispersing the fire extinguishing material over an abnormal fire and connected to the other end of the pipeline;
if an appliance is operated by a flammable gas, then a mechanically operated gas shut-off valve capable of instantly shutting off the gas supply and deployed on the appliance's gas supply line in proximity to the fire extinguisher system;
if the appliance is electrically operated, then a mechanically operated electric switch capable of instantly switching off an electricity supply and disposed on an appliance's electricity supply line in proximity to the fire extinguisher system;
a second mechanical link connecting the at least one fire condition detector fusible link with the gas shut off valve, if the appliance is gas operated, or to the electric switch, if the appliance is electrically operated, the mechanical link capable of transmitting with negligible loss of force an axial displacement force of sufficient strength to shut off the gas shut off valve or the electric switch upon the rupturing of the at least one fire condition detector fusible link; and
upon a fire condition that exceeds the at least one fire condition detector fusible link predetermined time and minimum temperature, the at least one fire condition detector fusible link rupturing and releasing the mechanical link and transmitting through it a displacement force capable of mechanically opening the canister access valve such that allows the fire extinguishing material to flow through the spout, pipeline, and nozzle, and be dispersed on the fire of the appliance and releasing the second mechanical link to shut-off the gas supply line, if gas operated, or switch-off the electrical switch, if electrically operated.

2. The fire detection and suppression system of claim 1, wherein the at least one fire condition detector fusible link is disposed preferably above a cooking appliance stove top area or where a continuing abnormal fire may occur.

3. The fire detection and suppression system of claim 1, wherein the canister access valve can be manually operated thus rupturing the at least one fire condition detector fusible link, dispensing the fire extinguishing material, and releasing the mechanical link.

4. An appliance fire detection and suppression system, the system comprising:
at least one fire condition detector capable of being activated upon being exposed to a fire condition for a predetermined minimum amount of time and a predetermined minimum temperature and capable of generating from said fire condition an electrical current;
a fire extinguisher system, disposed in proximity to the at least one fire condition detector and electrically connected to it, the fire extinguishing system comprising:
at least one canister, each of the at least one canister comprising:
a fire extinguishing material contained therein;
a canister access valve mechanically coupled to the canister, capable of controlling the flow of the fire extinguishing material through it and capable of being operated by the electrical current of the at least one fire condition detector, and
a spout through which the fire extinguishing material can flow;
a pipeline connected on one end to the fire extinguisher spout;
at least one nozzle connected to the other end of the pipeline and capable of dispensing and dispersing the fire extinguishing material;
if the appliance is operated by a flammable gas, then a gas shut-off valve capable of being operated by the electrical current of the at least one fire condition detector and capable of instantly shutting off the gas supply or;
if the appliance is electrically operated then an electric switch capable of being operated by the electrical current of the at least one fire condition detector and capable of instantly switch off an electricity supply;
an electrical link connecting the at least one fire condition detector with the canister access valve of the at least one canister and with either the gas shut-off valve, if the appliance is flammable gas operated, or the electric switch, if the appliance is electrically operated, the electrical link capable of transmitting the electrical current;
upon a fire condition that exceeds the predetermined time and minimum temperature of the at least one fire condition detector the at least one fire condition detector generating sufficient electricity to close the gas shut-off valve, if the appliance is flammable gas operated, or switch off the electrical switch, if the appliance is electrically operated, and open the canister access valve such that allows the fire extinguishing material to flow through the spout, pipe, and nozzle and be dispersed on a fire.

5. The fire detection and suppression system of claim 4, wherein the at least one fire condition detector fusible link is disposed preferably above an appliance top area or where a continuing abnormal fire may occur.

6. The fire detection and suppression system of claim 4, wherein the canister access valve can be manually operated thus rupturing the at least one fire condition detector fusible link and dispensing the fire extinguishing material.

7. The fire detection and suppression system of claim 4, wherein the at least one fire condition detector is a thermocouple.

8. A combustible material operated appliance fire detection and suppression system, the system comprising:
at least one fire condition detector fusible link capable of being activated upon being exposed to a fire condition for a predetermined minimum amount of time to a predetermined minimum temperature;
a fire extinguisher system disposed in proximity to the at least one fire condition detector fusible link and mechanically connected to it, the fire extinguishing system comprising:
at least one canister, each of the at least one canister comprising:
a fire extinguishing material contained therein;
a spout through which the fire extinguishing material can flow; and
a canister access valve, mechanically coupled to the canister on one end and to the spout on the other end, capable of controlling the flow of fire extinguishing material through it and capable of being mechanically operated;
a mechanical link coupling the at least one fire condition detector fusible link with the canister access valve, the mechanical link capable of transmitting with negligible loss of force an axial displacement force of sufficient strength to close the canister access valve upon breaking of the at least one fire condition heat detector fusible link;
a pipeline connected on one end to the fire extinguisher system spout and;
at least one nozzle capable of dispensing and dispersing the fire extinguishing material over a fire and connected to the other end of the pipeline;
upon a fire condition that exceeds the at least one fire condition detector fusible link predetermined time and minimum temperature the at least one fire condition detector fusible link releasing the mechanical link and transmitting through it a displacement force capable of mechanically opening the canister access valve such that allows the fire extinguishing material to flow through the spout, pipeline, and nozzle and be dispersed on the fire of the stove top.

9. The combustible material operated appliance fire detection and suppression system of claim 8, wherein the at least one fire condition detector fusible link is disposed preferably above an appliance top area or where a continuing abnormal fire may occur.

10. The fire detection and suppression system of claim 8, wherein the canister access valve can be manually operated thus rupturing the at least one fire condition detector fusible link and dispensing the fire extinguishing material.
